(19) United States
(12) Patent Application Publication
(10) Pub. No.: US 2015/0258498 A1
(43) Pub. Date: Sep. 17, 2015

(54) GRAPHENE-BASED MOLECULAR SEPARATION AND SEQUESTRATION DEVICE AND METHODS FOR HARVEST AND RECOVERY

(71) Applicant: LOCKHEED MARTIN CORPORATION, Bethesda, MD (US)

(72) Inventors: Sarah SIMON, Baltimore, MD (US); John B. STETSON, Jr., New Hope, PA (US)

(21) Appl. No.: 14/656,657

(22) Filed: Mar. 12, 2015

Related U.S. Application Data
(60) Provisional application No. 61/951,660, filed on Mar. 12, 2014.

(51) Int. Cl. B01D 57/02

(52) U.S. Cl. CPC B01D 57/02

(57) ABSTRACT

A device for separating a component from a medium includes at least one charging area to apply an electrical charge to the medium which aligns the medium according to a polarity of the electrical charge. At least one screening area is associated with the charging area to separate a component from the aligned medium.

### CROSS-REFERENCE TO RELATED APPLICATION

This application claims the benefit of U.S. provisional application 61/951,660, filed Mar. 12, 2014, which is incorporated by reference herein in its entirety.

### TECHNICAL FIELD

This disclosure is directed to separation and sequestration devices and their methods of operation.

### BACKGROUND OF THE INVENTION

Membrane technology is used in many phases of the pharmaceutical development processes, laboratory research and manufacturing.

As one example of a pharmaceutical product, proteins are sequestered for pharmaceutical applications and are typically produced from two sources, natural sources (e.g., plant, animal, including human sources) or recombinant expression systems (e.g., bacterial, yeast or mammalian cells). However, regardless the source, the feed stock containing such desirable products, will contain a heavily cluttered background of host cells, proteins, DNA and viruses.

Current filtration processes for proteins employ many distinct processing steps with different assays or tests in order to filter and isolate the protein of interest from the background. As an example, FIG. 1 shows the many steps for the purification of human recombinant Factor VIII.

Existing solutions leverage: physical and chemical properties with a variety of analytical methods as indicated in Table 1.

TABLE 1

| FRACTIONATION METHOD | PHYSICAL/CHEMICAL PROPERTY |
|---|---|
| Ultracentrifugation | Density |
| Size-exclusion chromatography | Stake's radius |
| Isoelectric focusing | Isoelectric point |
| Hydrophobic interaction | Hydrophobicity |
| chromatography | |
| Reversed-phase chromatography | Hydrophobicity |
| Ion-exchange chromatography | Charge |
| Affinity chromatography | Specific biomolecular interaction |
| Gel electrophoresis | Stake's radius |

The current state of the art methods for separation involve the sequential use of ionic (pH), convective, electrical, and diffusive forces acting on the proteins suspended in a semi-solid gel, filtration tubes, solutions, etc., to isolate and harvest one or more targeted proteins. There are many approaches available but that in most frequent use is affinity chromatography. Another aspect of the current processes is that multiple stages of final filtering using either size exclusion or unique molecular bonding to a substrate are required to narrow the distribution of proteins to render just the targeted molecule.

Prior systems are believed to be lacking as they may be complex, not amenable to continuous operation and/or may not provide a desired level of purity for the target protein(s) or other similarly sized molecules.

It is known to use a graphene membrane for separation as disclosed in U.S. Pat. No. 8,361,321, which is incorporated herein by reference. Such separations can also employ two-dimensional materials other than graphene. To further improve the separation process, the present invention provides adaptations of perforated two-dimensional materials, including graphene, which have high permeability and optionally electrical conductivity capable of reducing process steps, in conjunction with pH gradients and voltage gradients. The adaptations enable consolidation of filtration and separation to increase yield, purity/specificity, and reduce processing time by leveraging both size exclusion and isoelectric effects coupled with the perforated graphene. The adaptations are applicable to continuous or batch flow systems or combinations thereof. Furthermore, these limitations are germane to other industries; and the innovative methods and devices disclosed herein are applicable to other moieties or molecules.

### SUMMARY OF THE INVENTION

In light of the foregoing, it is a first aspect of the present invention to provide a graphene-based molecular separation and sequestration device and methods for harvest and recovery.

Another aspect of the present invention is to provide a device and method for separating a component from a medium, comprising at least one charging area to apply an electrical charge to the medium to align the components of the medium, including the desired or undesired molecules or moieties, according to an electrically driven gradient, in conjunction with at least one screening area associated with the charging area to separate a component from the aligned medium.

In an embodiment the invention provides a device for separating a target component from a medium, comprising:

at least one charging area to apply an electrical field to the medium and components therein which locates the components in the medium in a direction perpendicular to the applied electric field according to a component's electrophoretic mobility or isoelectric point; and

at least one screening area associated with said charging area to separate the target component from other components of selected electrophoretic mobility or isoelectric point,

wherein the screening area comprises a membrane of perforated two-dimensional material wherein the hole sizes are chosen to block passage of components larger than a selected size.

In an embodiment, the device further comprises:

at least one mixing area which receives the medium and components therein and a pH buffer solution to mix with the medium to establish a selected pH in the medium in the mixing area, wherein said medium and the components including the target component therein achieve a positional equilibrium according to the electrophoretic mobility of the components. In a further embodiment, the perforated two-dimensional membrane is positioned to selectively intersect with the positionally equilibrated components avoiding capture of the target component, yet capturing a portion of the components therein.

In an embodiment, the device further comprises:

at least one mixing area which receives the medium and components therein and an ampholyte mixture for establishing a pH gradient perpendicular to the electric field applied,

wherein said medium and the components including the target component therein achieve a positional equilibrium according to the isoelectric point of the components. The pH gradient established can ranges from 2-12, or 1-10 or 8-9, dependent upon components in the medium and the target component. In an embodiment, the perforated two-dimensional membrane is positioned to selectively intersect with the positionally equilibrated components avoiding capture of the target component, yet capturing a portion of the components therein.

In an embodiment the devices herein, said medium and the components including the target component therein additionally achieve a positional equilibrium according to the density of said components. In an embodiment, the perforated two-dimensional membrane is positioned to selectively intersect with the positionally equilibrated components avoiding capture of the target component, yet capturing a portion of the components therein.

In embodiments herein the two-dimensional material is conductive and the device further comprises a voltage source for application of a voltage to the perforated membrane of two-dimensional material.

In an embodiment, a device of the invention comprises one or more stages wherein a second stage (selectivity stage) comprises the at least one charging area to apply an electrical field to the medium and components therein which locates the components in the medium in a direction perpendicular to the applied electric field according to a component's electrophoretic mobility or isoelectric point; and

the at least one screening area associated with said charging area to separate the target component from other components of selected electrophoretic mobility or isoelectric point. In an embodiment, the second stage further comprises a mixing area which receives the medium and components therein and for introduction of a pH buffer solution to mix with the medium to establish a selected pH in the medium in the mixing area, wherein said medium and the components including the target component therein achieve a positional equilibrium according to the electrophoretic mobility of the components.

In an embodiment the perforated two-dimensional membrane of the second stage is positioned to selectively intersect with the positionally equilibrated components avoiding capture of the target component, yet capturing a portion of the components therein.

In an embodiment the second stage further comprises a mixing area which receives the medium and components therein and an ampholyte mixture for establishing a pH gradient perpendicular to the electric field applied, wherein said medium and the components including the target component therein achieve a positional equilibrium according to the isoelectric point of the components.

In an embodiment the second stage comprises a plurality of sub-stages wherein the pH established is different or where the pH range established is different.

In an embodiment, in the second stage said medium and the components including the target component therein additionally achieve a positional equilibrium according to the density of said components and the perforated two-dimensional membrane is positioned to selectively intersect with the positionally equilibrated components avoiding capture of the target component, yet capturing a portion of the components therein.

The two-dimensional material of the devices herein can be conductive and the device can further comprise voltage source for application of a voltage to the perforated membrane of two-dimensional material. The two-dimensional materials of the devices herein can be graphene-based material or graphene.

In a multiple stage device herein the device can further comprise a first stage providing a separation of components in the medium by density or by size. In a multiple stage device herein the device can further comprise a first stage providing a separation of components by size wherein separation by size is by passage of the medium through a perforated membrane of two-dimensional material.

In a multiple stage device herein the device can further comprise a third stage for comprising a perforated two-dimensional membrane for capturing the target component after its separation by electrophoretic mobility or isoelectric point. In this embodiment, a voltage can be applied to the membrane to facilitate collection of the target component.

In an embodiment, the invention provides a method for separating a target component from a medium containing the target component and other components which comprises: establishing a flow of medium applying an electric field perpendicular to the flow direction and locating the components of the medium including the target medium by position in the flow according to a component's electrophoretic mobility or isoelectric point and selectively intersecting the flow with a perforated membrane of two-dimensional material to avoid capture of the target component and capture at least a portion of the other components to thus separate the target component from other components. In an embodiment, the target component that is separated from other components can be captured on a perforated membrane of two-dimensional material.

### BRIEF DESCRIPTION OF THE DRAWINGS

These and other features and advantages of the present invention will become better understood with regard to the following description, appended claims, and accompanying drawings. The figures may or may not be drawn to scale and portions of certain parts may be exaggerated for convenience of illustration.

FIG. 1 illustrates a prior art method for purification of recombinant human factor VIII, see E. Casademunt et al. (2012) Eur. J. Haematol. 89(2):165-176.

FIG. 2 is a schematic representation of a separation and sequestration device according to the concepts of the present invention;

FIG. 3A is a schematic representation of one embodiment of a pre-filter stage, and FIG. 3B is a schematic representation of another embodiment of a pre-filter stage either of which may be utilized in the separation and sequestration device according to the concepts of the present invention;

FIG. 4 is a schematic representation of a selectivity stage incorporated into the separation and sequestration device according to the concepts of the present invention;

FIG. 5A is a schematic representation of an isolation stage of the separation and sequestration device according to the concepts of the present invention. FIG. 5B illustrates generation of standing waves on the membrane in the third isolation stage of the device. FIG. 5C illustrates positioning of the POI on the membrane in the third isolation stage of the device;

FIG. 6 is a schematic cross-section of a plenum showing the forces acting on a moiety of interest according to the concepts of the present invention; and

FIG. 7 is representative plot of predicted purity vs. displacement (X) in an exemplary device of the invention.

### DETAILED DESCRIPTION OF THE INVENTION

The present disclosure is directed to a perforated membrane used as a semi-permeable membrane for material harvesting and recovery applications along with pH/electric gradient filtering. The membrane and all other membranes disclosed herein may be made of graphene or other atomically thin (two-dimensional) material which is provided in a single sheet or few-layer configuration. Generally, graphene is, at a minimum, one atom in thickness, mechanically robust, tolerant of temperature and pH extremes and is electrically conductive so that it is able to impart charge-based forces on molecules on or near its surface. Such a membrane is an important component in the unique continuous flow device and method to separate molecules via this device of this invention. In one embodiment this device is used to harvest biologically active and other significant components of interest (e.g., biomolecules, viruses, cells and cell components) from a mixture of components. The components may include cells and cellular compounds (including proteins and bacteria), viruses (largely 20-50 nm in diameter, having several different shapes), and molecules, metals, ions and ionic compounds (0.1-˜1 nm in diameter). It is noted that proteins, nucleic acids and other biological molecules and other components, dependent upon the medium in which they are contained, can be charged species. Other components that may be sequestered or separated include, but are not limited to proteins (about 5 to 10 nm in diameter) and DNA (about 1 to about 3 nm in diameter). As such, the membranes in the embodiments disclosed may provide a general range for filtration between ˜1 nm-100 microns. Apertures provided in the membrane may be sized to allow passage of the components previously mentioned in the diameter ranges associated therewith. For example, if viruses are desired to be captured, then the apertures in the membranes will be sized from about 20 nm to about 50 nm, or anywhere within that range. The spacing and number of apertures through the membrane may also be adjusted as needed. The size of holes or apertures in the membranes employed in the devices of this invention will generally be correlated to the size of the components (e.g., molecules, viruses or cells) that are in the mixtures and which are targeted for separation. It will be appreciated that components of mixture may interact with holes or apertures requiring use of holes or apertures which may be larger than a calculated or measured size of the component. It will be appreciated that components of mixture may interact with other components or solvent requiring use of holes or apertures which may be larger than a calculated or measured size of the component. Indeed, as will become apparent as the description proceeds, the disclosed device and related methodologies may be used to selectively obtain a component from any medium that carries that component. The methods of the invention are particular useful to selectively obtain a target component from an aqueous medium, which include samples and extracts from plant and animal sources.

Existing pharmaceutical and industrial protein harvest is limited by the measures of effectiveness of yield (% of the desired molecule recovered from the feed stock per unit time), and purity (the % of the precise molecule relative to contaminating or non-active matter). With these market drivers in mind, the present disclosure is directed to a harvesting device which, in an embodiment, uses state of the art microfluidic principals together with the singular properties of perforated graphene-based materials. Preliminary estimates show that the disclosed system will improve yield by up to 2:1 over existing systems by being a continuous flow system vs. the current state batch/sequential systems, and improve purity by 1.5:1 using closed loop control of the component's is-electric equilibrium. In one embodiment, a component may be obtained with a unique continuous flow train by creating an electrical standing-wave in the graphene membrane to hyper-select moieties, any molecularly sized cell, or proteins of interest or the like at a specific location in the apparatus.

The device of the present invention can comprise multiple stages of separation arranged sequentially along a flow axis (in discussion and figures herein designated along the X axis). A flow of liquid, e.g., aqueous solution, containing at least one component of interest (target) as well as undesired components from which the target is to be separated, enters the device filling the plenum, with components mixed prior to or on entry. In an embodiment, the device comprises a stage (designated the second stage herein) having one or more sub-stages each employing a combination of electrical and physical forces to selectively locate the component of interest (e.g., POI, target) in the Y and Z direction with respect to the mixed state of components in the flow into the stage. A perforated membrane is selectively positioned to intersect flow in each sub-stage to capture undesired components and such that the component of interest (target) passes through the sub-stage. In combination, the one or more sub-stages each with a selectively positioned perforated membrane allow the target component to pass through the second stage while undesired components do not. A plurality of sub-stages may be required to achieve desired purity of the target. Alternative, a device may be provided with a set number of sub-stages (one, two or three, for example) and a plurality of passes through the device may be required to achieve desired purity of the target. It is noted herein and described below that isoelectric focusing of components in the YZ plane based on their isoelectric points can be accomplished in the second stage of the device herein.

In another embodiment, the device comprises a first stage preceding the second stage wherein a crude separation is performed employing one or more selectively perforated membrane capturing undesired components and allowing components of interest to pass to the second stage. For example, the first stage can simply provide size separation. It will be appreciated that the first stage could also encompass multiple chambers employing different methods of crude separation.

In another embodiment, the device comprises a third stage following the second stage wherein collection of the component of interest (target) is effected on a perforated membrane as described in detail below.

In an embodiment, a device of the invention combines a first stage optionally having multiple separation sub-stages, and a second stage optionally having multiple separation sub-stages. In an embodiment, a device of the invention combines a second stage optionally having multiple separation stages and a third stage. In an embodiment, a device of the invention combines, a first stage having optional multiple separation sub-stages, a second stage optionally having multiple separation sub-stages and a third stage. Devices of the invention include those having a second stage with a plurality of sub-stages, and/or those having a first stage with a plurality of sub-stages. It will be appreciated that the devices of the invention can be operated to separate and collect more than one target of interest in one or more passages through the device.

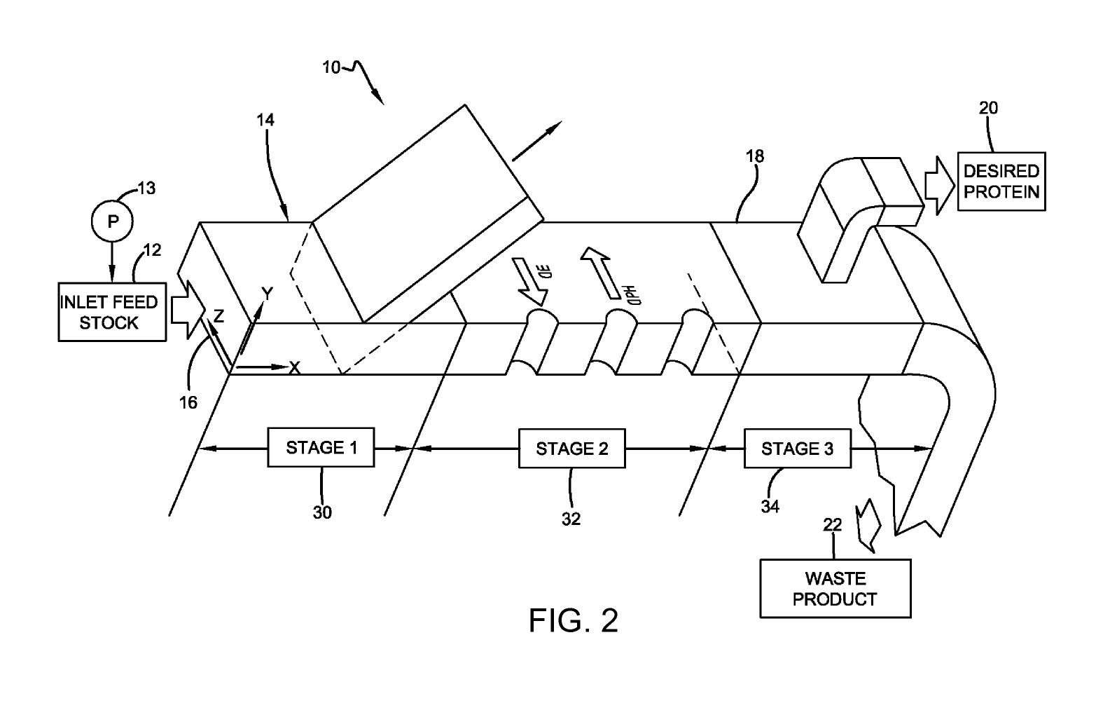

As will be described in further detail with reference to FIGS. 2, 3A, 3B, and 4-6, the component of interest (target) or more specifically, the protein(of interest (known hereafter as POI), enters from a left end of a plenum and progresses to the right. The primary flux velocity is in the +X direction. The role of a first stage is to effect crude waste separation using either methods of diffusive advection or size exclusion preferably employing a perforated membrane formed of high permeability perforated two-dimensional material. After a first size exclusion stage, the second stage uses a combination of a pH gradient, if necessary, created by a buffer solution introduced into the plenum, together with a voltage gradient—both in the Z direction—to create a stable location equilibrium point in the Z-direction where different proteins come to rest at their isoelectric equilibrium point, while diffusive flow and gravity create a stable location equilibrium point in the Y-direction where different proteins come to rest at their equilibrium point based on density and charges state. This approach uses a combination of force balance of electric, pH, density and viscous forces to locate a given protein at a particular range (or zone) in the Y and Z directions orthogonal to the principal flow in the X direction. Then at X-locations associated with the distance required to establish the pH gradient and the equilibrium Y and Z positions of the POI, high permeability selected aperture size filters (perforated two-dimensional materials) trap secondary proteins, or undesired constituents of the medium, that are not located at the desired isoelectric point location, for removal, while allowing the POI's to continue down the plenum. The second stage can contain multiple sub-stages providing for enhanced selectivity of Y and Z location. For example, sequential sub-stages in the second stage can be provided with different pH gradients. Removal of undesired constituents may be accomplished by means such as, but not limited to, aspiration, capture methods described below, washing and so on. Skilled artisans will appreciate that the removed components, moieties, proteins and the like could in fact be desired for further processing. An aspect of this design is that the second stage can contain a plurality of successive sub-stages where each sub-stage may be further infused with additional buffer solutions to change the pH gradient, e.g., narrow the pH gradient, to effectively amplify selectivity through the second stage

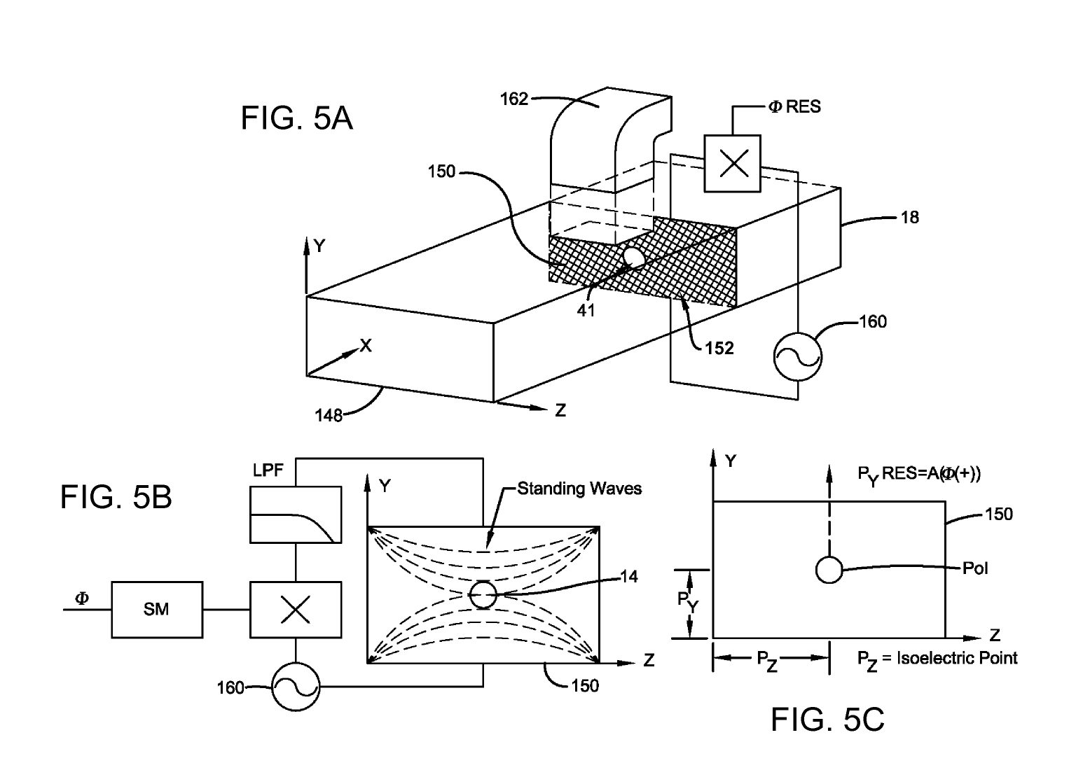

A third stage can be provided to complete the isolation of the desired protein(s) of interest using an electrically conductive high flux membrane, such as a perforated two-dimensional material-based membrane. After first trapping the remaining POIs on a the filter surface via size exclusion, an electrical standing wave applied to the conductive filter first coalesces the POIs to a fixed (y,z) location on the filter. Skilled artisans will appreciate that this may also be accomplished acoustically or by pressure waves. Then, by introduction of a phase difference between the +y and −y excitation plates, a standing wave forces the proteins to follow it to the +y extreme of the membrane and into an awaiting tube for low pressure aspiration and retention, harvest, sequestration and/or capture. The schematics in FIGS. 5A-Cshow an exemplary simple electrical circuit which can accomplish controlled migration of an adequate concentration of the POI up and into the plenum. This is accomplished by using a simple low pass filtering of an introduced harmonic excitation that modulates the standing wave phase. The resulting standing wave force is proportional to the phase difference as shown and with the viscous friction as the counterbalance, gradually drives the protein to capture. This methodology allows transformative throughput while maintaining selectivity and purity.

The capture of undesired components in the device of this invention is accomplished by use of semi-permeable filters having selective hole sizes, particularly in the nano-scale range (sub-nanometer to 100 nm). Hole sizes are selected to provide capture by inhibiting or preventing passage of components base done on their size. Preferably the nano-sized filtering is accomplished employing perforated two-dimensional materials where the perforations are sized to capture the undesired components without significant restriction to flow through the device.

Two-dimensional materials are, most generally, those which are atomically thin, with thickness from single-layer sub-nanometer thickness to a few nanometers, and which generally have a high surface area. Two-dimensional materials include metal chalogenides (e.g., transition metal dichalogenides), transition metal oxides, hexagonal boron nitride, graphene, silicone and germanene (see: Xu et al. (2013) “Graphene-like Two-Dimensional Materials) Chemical Reviews 113:3766-3798).

Two-dimensional materials include graphene, a graphene-based material, a transition metal dichalcogenide, molybdenum sulfide, α-boron nitride, silicone, germanene, or a combination thereof. Other nanomaterials having an extended two-dimensional, planar molecular structure can also constitute the two-dimensional material in the various embodiments of the present disclosure. For example, molybdenum sulfide is a representative chalcogenide having a two-dimensional molecular structure, and other various chalcogenides can constitute the two-dimensional material in an embodiments of the present disclosure. In another example, two-dimensional boron nitride can constitute the two-dimensional material in an embodiment of the invention. Choice of a suitable two-dimensional material for a particular application can be determined by a number of factors, including the chemical and physical environment into which the graphene, graphene-based or other two-dimensional material is to be deployed.

The technique used for forming the graphene or graphene-based material in the embodiments described herein is not believed to be particularly limited. For example, in some embodiments CVD graphene or graphene-based material can be used. In various embodiments, the CVD graphene or graphene-based material can be liberated from its growth substrate (e.g., Cu) and transferred to a polymer backing. Likewise, the techniques for introducing perforations to the graphene or graphene-based material are also not believed to be particularly limited, other than being chosen to produce perforations within a desired size range. Perforations are sized as described herein to provide desired selective permeability of a species (atom, molecule, protein, virus, cell, etc.) for a given application. Selective permeability relates to the propensity of a porous material or a perforated two-dimensional material to allow passage (or transport) of one or more species more readily or faster than other species. Selective permeability allows separation of species which exhibit different passage or transport rates. In two-dimensional materials selective permeability correlates to the dimension or size (e.g., diameter) of apertures and the relative effective size of the species to be passed through or rejected by the holes. Selective permeability of the perforations in two-dimensional materials such as graphene-based materials can also depend on functionalization of perforations (if any) and the specific species that are to be separated. Separation of two or more species in a mixture includes a change in the ratio(s) (weight or molar ratio) of the two or more species in the mixture after passage of the mixture through a perforated two-dimensional material.

In other embodiments, perforations are dimensioned to range between about 5 to 10 angstroms. In other embodiments, perforations are dimensioned to range from 5 to 20 angstroms. It will be appreciated that perforations can be otherwise dimensioned dependent upon the species that are present in the medium from which water is to be removed. Perforations of a selected size can have a 1-10% deviation or a 1-20% deviation from the selected size For circular holes, the characteristic dimension is the diameter of the hole. In embodiments relevant to non-circular pores, the characteristic dimension can be taken as the largest distance spanning the hole, the smallest distance spanning the hole, the average of the largest and smallest distance spanning the hole, or an equivalent diameter based on the in-plane area of the pore. As used herein, perforated graphene-based materials include materials in which non-carbon atoms have been incorporated at the edges of the pores.

Graphene represents a form of carbon in which the carbon atoms reside within a single atomically thin sheet or a few layered sheets (e.g., about 20 or less) of fused six-membered rings forming an extended sp2-hybridized carbon planar lattice. In its various forms, graphene has garnered widespread interest for use in a number of applications, primarily due to its favorable combination of high electrical and thermal conductivity values, good in-plane mechanical strength, and unique optical and electronic properties. Other two-dimensional materials having a thickness of a few nanometers or less and an extended planar lattice are also of interest for various applications. In an embodiment, a two dimensional material has a thickness of 0.3 to 1.2 nm. In other embodiment, a two dimensional material has a thickness of 0.3 to 3 nm

The process of forming holes in graphene and other two-dimensional materials will be referred to herein as “perforation,” and such nanomaterials will be referred to herein as being “perforated.” In a graphene sheet an interstitial aperture is formed by each six carbon atom ring structure in the sheet and this interstitial aperture is less than one nanometer across. In particular, this interstitial aperture is believed to be about 0.3 nanometers across its longest dimension (the center to center distance between carbon atoms being about 0.28 nm and the aperture being somewhat smaller than this distance). Perforation of sheets comprising two-dimensional network structures typically refers to formation of holes larger than the interstitial apertures in the network structure. Due to the atomic-level thinness of graphene and other two-dimensional materials, it can be possible to achieve high liquid throughput fluxes during filtration processes, even with holes being present that are nanoscale in size.

Chemical techniques can be used to create holes in graphene and other two-dimensional materials. Exposure of graphene or another two-dimensional material to ozone or an atmospheric pressure plasma (e.g., an oxygen/argon or nitrogen/argon plasma) can effect perforation. Physical techniques can also be used to remove matter from the planar structure of two-dimensional materials in order to create holes.

In various embodiments, the two-dimensional material comprises a sheet of a graphene-based material. In an embodiment, the first layer comprises a sheet of a graphene-based material. In an embodiment, the sheet of graphene-based material is a sheet of single or multilayer graphene or a sheet comprising a plurality of interconnected single or multilayer graphene domains. In embodiments, the multilayer graphene domains have 2 to 5 layers or 2 to 10 layers. In an embodiment, the layer comprising the sheet of graphene-based material further comprises non-graphenic carbon-based material located on the surface of the sheet of graphene-based material. In an embodiment, the amount of non-graphenic carbon-based material is less than the amount of graphene. In embodiments, the amount of graphene in the graphene-based material is from 60% to 95% or from 75% to 100%.

In embodiments, the characteristic size of the perforation is from 0.3 to 10 nm, from 0.3 to 0.5 nm, from 0.4 to 10 nm, from 0.5 to 2.5 nm, from 0.5 to 10 nm, from 5 nm to 20 nm, from 0.7 nm to 1.2 nm, from 10 nm to 50 nm, from 50 nm to 100 nm from 50 nm to 150 nm, or from 100 nm to 200 nm. In an embodiment, the average pore size is within the specified range. In embodiments, 70% to 99%, 80% to 99%, 85% to 99% or 90 to 99% of the perforations fall within a specified range, but other pores fall outside the specified range. If the pores falling outside the specified range are larger than specified in the range, these pores may be termed “non-selective.”

Graphene-based materials include, but are not limited to, single layer graphene, multilayer graphene or interconnected single or multilayer graphene domains and combinations thereof. In an embodiment, graphene-based materials also include materials which have been formed by stacking single or multilayer graphene sheets. In embodiments, multilayer graphene includes 2 to 20 layers, 2 to 10 layers or 2 to 5 layers. In embodiments, graphene is the dominant material in a graphene-based material. For example, a graphene-based material comprises at least 30% graphene, or at least 40% graphene, or at least 50% graphene, or at least 60% graphene, or at least 70% graphene, or at least 80% graphene, or at least 90% graphene, or at least 95% graphene. In embodiments, a graphene-based material comprises a range of graphene selected from 30% to 95%, or from 40% to 80% from 50% to 70%, from 60% to 95% or from 75% to 100%.

As used herein, a “domain” refers to a region of a material where atoms are uniformly ordered into a crystal lattice, A domain is uniform within its boundaries, but different from a neighboring region. For example, a single crystalline material has a single domain of ordered atoms. In an embodiment, at least some of the graphene domains are nanocrystals, having domain size from 1 to 100 nm or 10-100 nm. In an embodiment, at least some of the graphene domains have a domain size greater than 100 nm to 1 micron, or from 200 nm to 800 nm, or from 300 nm to 500 nm “Grain boundaries” formed by crystallographic defects at edges of each domain differentiate between neighboring crystal lattices. In some embodiments, a first crystal lattice may be rotated relative to a second crystal lattice, by rotation about an axis perpendicular to the plane of a sheet, such that the two lattices differ in “crystal lattice orientation”.

In an embodiment, the sheet of graphene-based material comprises a sheet of single or multilayer graphene or a combination thereof. In an embodiment, the sheet of graphene-based material is a sheet of single or multilayer graphene or a combination thereof. In another embodiment, the sheet of graphene-based material is a sheet comprising a plurality of interconnected single or multilayer graphene domains. In an embodiment, the interconnected domains are covalently bonded together to form the sheet. When the domains in a sheet differ in crystal lattice orientation, the sheet is polycrystalline.

In embodiments, the thickness of the sheet of graphene-based material is from 0.34 to 10 nm, from 0.34 to 5 nm, or from 0.34 to 3 nm. In an embodiment, a sheet of graphene-based material comprises intrinsic defects. Intrinsic defects are those resulting from preparation of the graphene-based material in contrast to perforations which are selectively introduced into a sheet of graphene-based material or a sheet of graphene. Such intrinsic defects include, but are not limited to, lattice anomalies, pores, tears, cracks or wrinkles. Lattice anomalies can include, but are not limited to, carbon rings with other than 6 members (e.g. 5, 7 or 9 membered rings), vacancies, interstitial defects (including incorporation of non-carbon atoms in the lattice), and grain boundaries.

In an embodiment, the layer comprising the sheet of graphene-based material further comprises non-graphenic carbon-based material located on the surface of the sheet of graphene-based material. In an embodiment, the non-graphenic carbon-based material does not possess long range order and may be classified as amorphous. In embodiments, the non-graphenic carbon-based material further comprises elements other than carbon and/or hydrocarbons. Non-carbon elements which may be incorporated in the non-graphenic carbon include, but are not limited to, hydrogen, oxygen, silicon, copper and iron. In embodiments, the non-graphenic carbon-based material comprises hydrocarbons. In embodiments, carbon is the dominant material in non-graphenic carbon-based material. For example, a non-graphenic carbon-based material comprises at least 30% carbon, or at least 40% carbon, or at least 50% carbon, or at least 60% carbon, or at least 70% carbon, or at least 80% carbon, or at least 90% carbon, or at least 95% carbon. In embodiments, a non-graphenic carbon-based material comprises a range of carbon selected from 30% to 95%, or from 40% to 80%, or from 50% to 70%.

Such nanomaterials in which pores are intentionally created will be referred to herein as “perforated graphene”, “perforated graphene-based materials” or “perforated two-dimensional materials.” The present disclosure is also directed, in part, to perforated graphene, perforated graphene-based materials and other perforated two-dimensional materials containing a plurality of holes ranging from about 0.3 nm to about 10 nm in size. The present disclosure is further directed, in part, to perforated graphene, perforated graphene-based materials and other perforated two-dimensional materials containing a plurality of holes ranging from about 0.3 nm to about 10 nm in size and having a narrow size distribution, including but not limited to a 1-10% deviation in size or a 1-20% deviation in size. In an embodiment, the characteristic dimension of the holes is from 0.5 nm to 10 nm. For circular holes, the characteristic dimension is the diameter of the hole. In embodiments relevant to non-circular pores, the characteristic dimension can be taken as the largest distance spanning the hole, the smallest distance spanning the hole, the average of the largest and smallest distance spanning the hole, or an equivalent diameter based on the in-plane area of the pore. As used herein, perforated graphene-based materials include materials in which non-carbon atoms have been incorporated at the edges of the pores

In various embodiments, the two-dimensional material comprises graphene, molybdenum sulfide, or boron nitride. In more particular embodiments, the two-dimensional material can be graphene. Graphene according to the embodiments of the present disclosure can include single-layer graphene, multi-layer graphene, or any combination thereof. Other nanomaterials having an extended two-dimensional molecular structure can also constitute the two-dimensional material in the various embodiments of the present disclosure. For example, molybdenum sulfide is a representative chalcogenide having a two-dimensional molecular structure, and other various chalcogenides can constitute the two-dimensional material in the embodiments of the present disclosure. Choice of a suitable two-dimensional material for a particular application can be determined by a number of factors, including the chemical and physical environment into which the graphene or other two-dimensional material is to be terminally deployed.

The use of graphene in a biological application excels because of its strength, thinness, permeability, electrical conductance, and chemical and biological neutrality. The unique application of graphene leverages not only size exclusion, but also the electrical properties to provide a singular solution. Furthermore, the design components, together can be envisioned to provide a continuous, uninterrupted process that is fully automated and closed loop controlled versus sequential open loop batch, although it can be used in this batch way, as well as high purity rendering process that provides significantly improved selectivity but does not need to be stopped to harvest the desired molecule.

Applications for this device and process include: proteins or any charged moiety for capture, harvest, migration for use in lab or pharma manufacturing processes, as well as for use in devices for rapid diagnostics in the field or laboratory, or used in vivo for capture or elution, etc.

In an embodiment, a system design of the invention exploits the specific properties of a component or moiety of interest or other component in a mixture of undesired moieties or components with design steps optimized for size exclusion, isoelectric point location, and a unique and disruptive method of electrically actuated, standing wave based harvest both around and on a graphene membrane for high yield, purity, and minimized operating time in a continuous flow configuration, of which any or all can be used.

Referring now to FIG. 2 it can be seen that molecular separation and sequestration device based on use of perforated two-dimensional material is designated generally by the numeral 10. The device 10 allows for separation and purification of selected components, as described above, in a continuous-flow process. Although the device 10 described herein is utilized for selecting and separating a protein from all other material in a carrier medium (typically aqueous) with which the desired protein is associated, skilled artisans will appreciate that the process disclosed herein may be used to obtain or separate components, such as viruses, cells, portions of cells, or cell organelle, as well as other biological molecules (e.g., nucleic acids) or other molecules, particularly those isolated from natural sources.

By reference to FIG. 2, the process starts by utilizing a feed stock 12 which contains the component to be purified and a carrier material or medium from which the desired component is to be separated. In an embodiment, the feed stock has a selected pH. Most typically, the medium contains components as described herein from which the desired component is to be separated. The feed stock 12 is introduced by a pump 13 or other similar device or force into a process plenum 14. As a matter of reference, an XYZ orientation is utilized wherein X designates the flow of the material along a length of the plenum, Y represents a height of the plenum and Z represents a width of the plenum. Although the plenum is shown as a rectangular configuration, skilled artisans will appreciate that the cross-sectional shape of the plenum may be in any configuration conducive to the flow and operation of the device 10. The plenums may be sized for microfluidics up to plenums feet wide or larger. Moreover, different size plenums connected in series may be used. The plenum 14 provides an entry plenum 16 where the feed stock enters and a plenum end 18 where a desired protein collector 20 and a waste product collector 22 are provided.

The device 10 provides three distinct stages. Starting at the entry plenum 16 is a pre-filter stage (first stage) designated generally by the numeral 30. After the feed stock has gone through the pre-filter stage, the material not blocked or excluded by the pre-filter stage enters a selectivity stage 32 (second stage) which further purifies the desired protein material and removes or diverts the unwanted material. As will be described, the selectivity stage may comprise a single stage or multiple sub-stages. At the end of the plenum 14, downstream from the selectivity stage, is an isolation stage (third sage) designated generally by the numeral 34. Upon completion of the selectivity stage or stages 32, the desired protein material enters the isolation stage 34 and undergoes a final processing step to further purify and isolate the desired protein material. Depending upon the component to be obtained, as indicated above, any one or any combination of the stages and/or sub-stages may be utilized. Preferably, the device comprises the second stage in combination with one or both of the first and third stages.

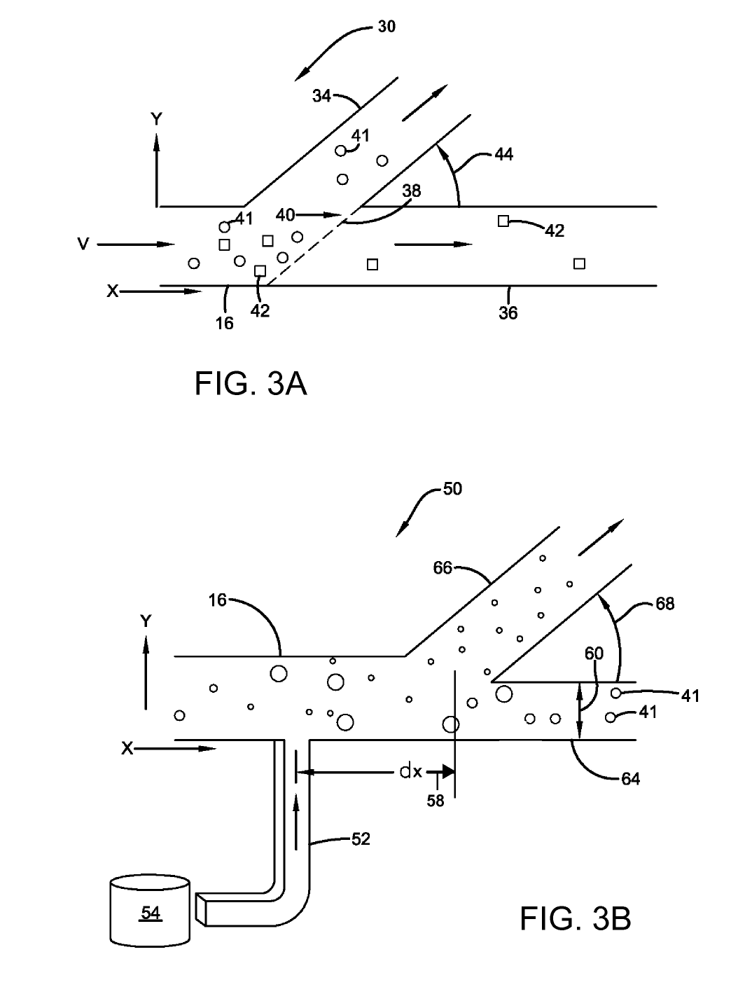

Referring now to FIGS. 3A and 3B, it can be seen that the pre-filter stage 30 can be provided in two different embodiments. As best seen in FIG. 3A, a bulk-flow, pre-filter stage is designated generally by the numeral 30. As shown, the V vector represents the flow of the material though the plenum, and X and Y represent the length and height respectively of the plenum. The stage 30 includes the entry plenum 16 which separates into a component pre-filter plenum 34 and a pre-filter waste plenum 36. Disposed at an entry point of the pre-filter waste plenum 36 is a membrane 38 which has a plurality of pre-determined size perforations or apertures 40. The apertures 40 are sized so as to allow the waste material to pass through while blocking proteins of interest on the surface of the membrane 38. Note that the apertures are selected to at least block the protein of interest. Accordingly, the component, such as a protein of interest, designated generally by the numeral 41 and represented by the circles is deflected into the plenum 34 while the waste material 42, represented by squares, is allowed to pass through the openings and is directed into the waste plenum 36. The size of the apertures 40 will be selected so as to allow material sized smaller than the size of the protein of interest to pass through into the plenum 36, while the protein of interest 41 and any similarly sized and larger molecules will be directed into the pre-filter plenum 34. It will be appreciated that apertures are preferably selected to be as large as possible to block a protein of interest such that small components will be directed to waste and to avoid undesirable flow restriction. It will also be appreciated that a plenum angle 44 is imparted to the orientation of the membrane 38.

Accordingly, the feed stock flows into the entry plenum 16 and is directed on to membrane 38. This flow assists in moving the non-blocked material through the membrane while the angular positioning of the membrane 38 keeps the desired POI 41 from accumulating on the surface of the membrane. As a result, the flow or flux of the feed stock assists in moving the POI 41 and any larger sized material into the plenum 34. Skilled artisans will appreciate that the plenum angle 44 may be anywhere from about 5 degrees to about or near 85 degrees and selection of the angle 44 depends on characteristics of the flow velocity in the X direction and the material desired to be passed through the membrane and the material desired to be rejected by the membrane. In most embodiments, it is envisioned that the plenum angle will be about 45 degrees, but as indicated other angles may suffice.

In another embodiment, shown in FIG. 3B, a micro-fluidic first stage is designated generally by the numeral 50. This embodiment has a main entry plenum 16 which divides into a waste plenum and an exit plenum 64 which passes on to possible further separation in the first stage or onto stage 2. The embodiment utilizes a buffer plenum 52 which allows for entry of a buffer solution 54. The buffer solution 54 mixes with the feed stock in such a way that the protein of interest 41 migrates to an equilibrium height δy in the Y direction within the flow distance δx designated generally by the numeral 58. In this distance, δy the protein of interest 41 is such that it enters the exit plenum 64. In other words, the protein of interest 41 rises to a level less than the flow separation height 60. The buffer plenum is shown as entering the main plenum at a 90° angle at a certain distance from the point where the flows separate. It will be appreciated that this angle of entry of buffer and the distance between its entry and the point of flow separation can be varied so long as the δy for the protein of interest 41 is such that it enters the exit plenum 64. The diffusion after mixing of the buffer solution with the feed stock and its components is such that larger molecules in the feed stock tend to stay in the lower flow path while smaller molecules tend to move into the upper flow path into waste plenum 66. Accordingly, the protein of interest 41 is directed into the pre-filter exit plenum 64 while the other material flows into the waste plenum 66. A plenum angle 68 is positioned so as to intersect the material at the flow separation distance 60 which assists in separation of the desired proteins of interest and any material larger from the waste material included in the feed stock and any of the unnecessary buffer solution material. It will be appreciated that in an embodiment, plenum 66 could be directed to further purification while plenum 64 could be directed to waste. In this embodiment, it would be small components that would be of interest for further purification and large components would be separated and directed into waste. It will also be appreciated that both of plenums 66 and 64 could be directed for further separation, for example into separate second stages.

In either embodiment shown in FIG. 3A or FIG. 3B, the protein of interest flows into a selectivity stage 32 as will be described. It will be appreciated that the first stage can have multiple first stages. For example, a device may combine one or more sub-stage as in FIG. 3A with one or more sub-stages as in FIG. 3B. In another example, multiple sub-stages of FIG. 3A wherein different pore sizes are employed can be employed. In another example, multiple sub-stages of FIG. 3B can be employed in sequence wherein the geometry of the plenums is the same of different.

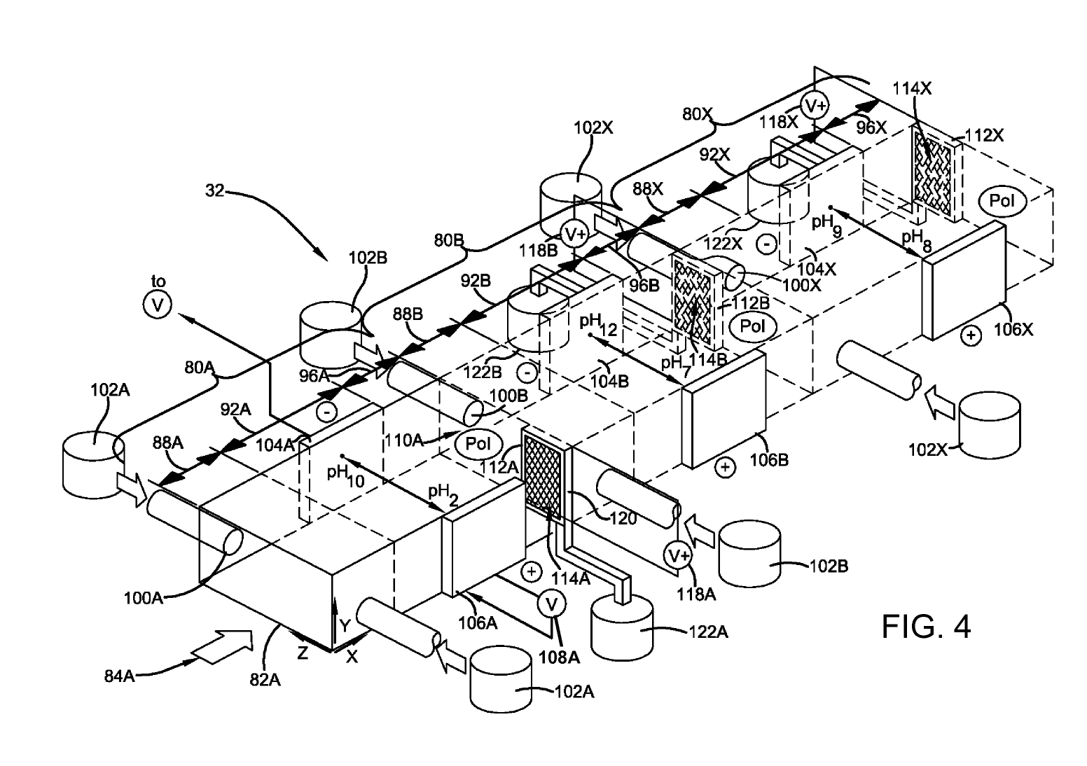

Referring now to FIG. 4, the selectivity stage is designated generally by the numeral 32. Three sub-stages are shown, but skilled artisans will appreciate fewer or more sub-stages may be utilized and in particular that only one sub-stage may be utilized. The number of sub-stages utilized depends on the protein of interest or the like and the material(s) or medium to be excluded therefrom. If multiple stages are used, then the positional relations of the components in each sub-stage may be dependent upon how the other sub-stages are configured. Each sub-stage may provide any number of exclusionary variables. The first variable relates to the possible dynamic or static pH material injected into the stage, the second variable relates to a possible variable electrical charge applied across the plenum in the sub-stage and the third relates to selection, size (with respect to the flow area) and positioning of a perforated two-dimensional material membrane. In each stage, the flowing stream (feed stock and any added buffer) can have a selected pH or a pH gradient can be established in the stage by appropriate addition of ampholyte mixtures. The establishment of buffer gradients by such additions is known in the art. In some embodiments, the density of the component may also be a variable that is used to separate a desired component from the medium. The relevance of each variable will be discussed.

The sub-stages are designated generally by the numeral 80 and an appropriate suffix. For example, the first sub-stage is designated generally by the designation 80A and the second sub-stage is designated as 80B. A final sub-stage is designated generally by the designation 80X as it will be appreciated that any number of sub-stages between B and X may be utilized. All of the sub-stages allow for a continuous flow of the material through the plenum and each stage further separates the protein of interest from all other material.

Sub-stage 80A provides a plenum 82A which is connected to the plenum 34/64 that is not the waste plenum 36/66 from the pre-filter stage 32/50. The plenum 82A receives a pre-filter material 84A which includes at least the protein of interest 41 and may have other material associated therewith. Each sub-stage may be, in some embodiments, sequentially separated into a mixing area 88A, a charging area 92A and a screening area 96A. Each of these areas 88A, 92A, and 96A provide a variable which allows for further separation of the protein of interest from other material. Any combination and/or sequencing of the areas may be employed.

In the mixing area 88A, at least one and possibly more injection points 100A are provided. Each of the injections points 100A receive and transmit into the mixing area 80A a material 102A. The material 102A can be a buffer having a selected pH value which will establish a selected pH in the flow in the device in the sub-stage. Alternatively, material 102A is introduced into the flow through the stage to establish a pH gradient therein. For example, ampholyte mixtures can be introduced into a sub-stage to establish a pH gradient perpendicular to flow. The pH range of the pH gradient can be selected as is known the art by choice of materials introduced. The pH range for a given sub-stage can be broad, for example, a pH gradient of range of 2-10 can be used. In the mixing area, the pre-filter material mixes with the introduced material 102A. The mixing area 88A is defined by a length distance of the mixing stage 88A. Of course, the X distance of any mixing stage 88 may be adjusted so as to ensure complete mixing of the buffer material, the protein of interest and all other material that is received in the plenum 82. The length of the mixing area can be adjusted if desired to allow for establish of a desired pH gradient. A pH gradient can be assessed, if desired, by introduction of appropriate pH indicators into the flow stream. Such indicators can be used to adjust inputs 102A into the flow to obtain a desired pH gradient.

Adjacent and downstream from the mixing area 88A is a charging area 92A. The charging area 92A includes a pair of opposed charge plates wherein a charge plate 104A is a positively charged plate on one vertical side of the plenum that is opposed by a negatively charged charge plate 106A on an opposite side of the plenum. A voltage source 108A is connected across the charge plates outside of the plenum. Skilled artisans will appreciate that the voltage source 108A may allow for a variable voltage adjustment so that the amount of voltage may be varied during the operation. In any event, the voltage source 108A generates a voltage gradient across the plenum in the Z direction. As a result of this voltage gradient, charged species in the flow will migrate (to a Z position or range of positions) in the electric field applied perpendicular to flow. If the flow has a selected pH, components in the flow migrate according to their electrophoretic mobility and the strength of the applied electric field. Upon choice of pH and strength of applied field, a component of interest will be located to a Z position. If the flow has a selected pH gradient, components in the flow migrate in the gradient and thus to a Z position according to their isoelectric point and the strength of the applied electric field. Upon choice of pH gradient and strength of applied field, a component of interest will be located to a Z position associated with its isoelectric point according to the voltage values applied.

It will further be appreciated that differentiation in the Y direction can also develop. This differentiation in the Y direction is a result of density in flow; the smaller, less dense proteins migrating toward the top of the plenum, while denser proteins migrate near the middle portion of the plenum along the Y axis and larger, and even denser proteins of interest and other like density material accumulate closer toward the bottom of the plenum. As will be discussed, the density of the proteins or components may provide another way to separate the component from the medium which carries the component.

After the material has completed flowing through the charging area 92A, it enters a screening area 96A. The screening area includes an open gate 110A aligned along one side of the flow area in the Z direction and a membrane of perforated two-dimensional material, 112A aligned along an opposite side of the flow plenum. This membrane 112A has a plurality of appropriately sized apertures 114A wherein the apertures allow smaller sized material to pass through while material larger than the apertures 114A accumulates on the membrane 112A. Skilled artisans will appreciate that the positioning of the gate 110A and the screen 112A may be switched depending upon the selection process. It will further be appreciated that the dimensions in the Z direction and X direction of the gate 110A and screen 112A may be adjusted as appropriate. For example, the membrane 112A can be positioned at a selected position along the Z direction and along the Y direction and the dimensions of the membrane itself relative to YZ area of the plenum can be selected to achieve desired collection. Moreover, in some embodiments the screening area may employ an open gate aligned along the Z axis so as to pass and reject a component according to its density. For example, if it is desired to capture denser components or particles, the graphene membrane may be positioned across the entire lower portion of the Z axis and extend up a predetermined distance along the Y axis. Less dense particles will pass over such a membrane and through the open gate. The denser particles that are sized small enough to pass through the apertures of the membrane will still pass through.

For example, in the embodiment where a pH gradient ranging from 2 to 10 is utilized, the components align in quasi-columns according to their isoelectric point (pI). As a result, components with lower pI are aligned closer to the side of the plenum with the positive voltage while the higher value pI materials will migrate in corresponding quasi-columns toward the side of the plenum with the negative voltage. Of course, the polarity of the plates could be reversed depending upon the particular application. As a result the lower value pI materials are directed to the flow area of the membrane while the higher pI value material is directed into the open gate area 110A. This allows for material with pI values ranging from, for example, 5 to 10 to easily pass through the open gate 110A while the other materials with pI values ranging from 2 to 5 are directed toward the membrane 114A. This allows for removal of materials in the feed stock that are associated with lower pI values, such as 2 to 5 and associated proteins of interest or components that are of the appropriate size to pass through while the larger materials associated with pI values of 2 to 5 collected on the graphene screen and deposited into the collection vessel 122A.

A screen voltage 118 may be applied to the graphene membrane 112A so as to energize the screen. As a result any material that accumulates on the surface of the membrane, i.e., material that is not allowed to pass through the membrane and which has a pI value of about 2-5, can be electrically driven to an area on the screen associated with a collection tube 120A. This collection tube or other physical embodiment evident to those skilled in the art accumulates the blocked or screened material which can then be deposited into a collection vessel 122A. In the alternative the accumulated material can be collected into something else or as needed by a particular end use.

As best seen in FIG. 4, multiple stages can be provided. For example, the subsequent stage 80 has similar numerals as in the first stage but with B suffixes while a third stage may be provided with the X suffixes. Skilled artisans will appreciate that any number of stages can be employed in the selectivity stage. So for example, the second sub-stage will be of a similar construction, but the buffer gradient may have pH values of only 7 to 12. Alternatively, a selected specific pH may be selected for the sub-stage. A charging area 92B may be employed to segregate the material flowing there through. In this particular embodiment, with a pH gradient of 7 to 12, a perforated membrane 114B may be placed on the left side of the plenum with an open area 110B provided on the right side of the plenum. Accordingly, the material associated with pI values of 7 to 10 are allowed to pass through the open area 110B while those with pI values of 10 to 12 are directed toward the membrane 114B. As such, the material blocked by the membrane, is then accumulated in the appropriate collection vessel 122B by an electrical driving force while still allowing the particles of interest smaller than the apertures 114B and having pI values of 10 to 12 to pass through to the next stage or sub-stage.

In a final sub-stage having an X suffix, and in a manner similar to the previously described sub-stage, a pH gradient of 8-9 is established. A perforated membrane 114X may be placed on the left side of the plenum with an open area 110X provided on the right side of the plenum, such that components having pI of 8 are allowed to pass through an open area 110X while components having pI of 9 are impacted upon a corresponding graphene membrane 114X. The exemplified series of pH gradient sub-stages lead to separation of components of pI 8 from components the pI of which is different.

Upon passing through the selectivity stage 32, skilled artisans will appreciate that proteins of interest associated with a specific pI value and a desired size have been separated from other material. As such, the material is then prepared to pass through the final isolation (third) stage.

As seen in FIG. 5A, the isolation (third) stage provides for an entry plenum 148 that receives the flow of material from the selectivity stage 32. A perforated membrane 150 is orthogonally positioned across the entire flow path at a selected position along the X axis. The perforated membrane 150 has a plurality of apertures 152 wherein the protein of interest 41 is captured on the membrane while the smaller material that is of no interest is allowed to pass through the membrane apertures 152 and flow into the return/waste plenum 18 and then into the waste product collector 22 (FIG. 2). Note that undesired materials of similar or larger size have been previously removed at least decreasing the amount present in the flow.

For the protein of interest that accumulates on the graphene membrane, the proteins are driven or otherwise moved by a standing wave generator 160 that is connected to the graphene membrane. The standing wave generator allows for a specified wave to be passed through the graphene membrane such that the proteins of interest are physically moved from their location on the membrane toward a collection or protein of interest plenum 162 and then into product collector 20 (FIG. 2). As such, the material has been purified and collected. It will be appreciated that in some cases, the material collected after passage through the device may contain undesirable levels of undesirable components. Collected material enriched in the target component can if desired or needed be subjected to a second or further passes through the device to provide target component of a desired level of purity.

An electrical standing wave first coalesces the proteins to a fixed (y,z) location. Then, by introduction of a phase difference between the +y and −y excitation plates, a standing wave forces the proteins to follow it to the +y extreme of the membrane and into an awaiting tube or other collector for retention in any number of ways as previously noted. FIG. 5C is a planar view of the perforated two-dimensional membrane of the third stage illustrating the POI located at (x, y) FIG. 5B shows an exemplary simple electrical circuit to accomplish controlled migration of an adequate concentration of the POI up and into the plenum. This is accomplished by using a simple low pass filtering of an introduced harmonic excitation that modulates the standing wave phase. The resulting standing wave force is proportional to the phase difference as shown and with the viscous friction as the counterbalance, gradually drives the protein to capture. This inventive methodology is central to achieving transformative throughput while maintaining selectivity and purity.

US published patent application 20130277305, published Oct. 24, 2013 relates among others to use of application of voltage to perforated graphene-based membranes, and other methods, to dislodge substances from the membranes. Such methods are applicable generally to perforated two-dimensional membranes used in the present invention. The description of the devices and methods of this published application are incorporated by reference herein as useful in the devices and methods of this invention. US published application 20130248367, published Sep. 26, 2013 relates to electrical charging of graphene-based membranes to facilitate certain separations. Such methods are applicable generally to perforated two-dimensional membranes used in the present invention. The description of the devices and methods of this published application are incorporated by reference herein as useful in the devices and methods of this invention.

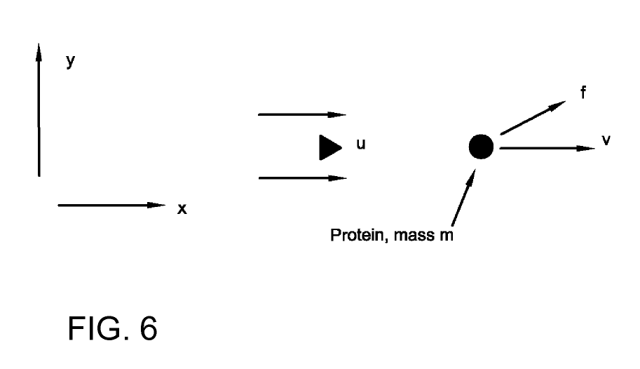

The following discussion relates to how the flow of the proteins of interest can be understood and modeled as it relates to the previous discussion of the device 10. FIG. 6 shows a notional protein molecule suspended in an aqueous buffered solution, represented in a 2D Newtonian Cartesian (x, y) inertial frame (this is for simplicity but inclusion of the z-dimension is straightforward). The bulk fluid velocity vector (u [m/s]) is assumed for purposes consistent with this process to be Newtonian and will later be assumed to be at steady state flow. With the fluid represented as a continuum with density (r [kg/m3]), viscosity (h [Pa-s]), pressure p ([Pa]) and the protein considered a flexible body with an aggregate center of mass (m[kg]) in general translational motion with velocity v ([m/s]) within the fluid, the Navier Stokes equation together with a comprehensive force summation on the protein fully describes its vector motion. Note that the total protein velocity is the sum of the bulk fluid velocity and its local body velocity relative to the fluid as shown in Equation 4) In the forthcoming equations, the superscript (i) indicates the Newtonian inertial frame, and (b) indicates the protein body frame.

Equations 6) and 7) describe the general motion of the protein relative to the inertial (i.e. the channel) frame. It is important to note that this formulation is critically important to discern the forces that separate the protein from the general fluid motion generating the all-important selectivity as a function of inertial displacement (location within the channel device). The total protein motion is the solution of Equation 4 which uses the solution for Equations 6 & 7.

$$1 ) {u}^{i} = {[ ux , uy , uz ]}^{T} \\ 2 ) {v}^{b} = {[ vx , vy , vz ]}^{T} \\ 3 ) p = {[ px , py , pz ]}^{T} \\ 4 ) {v}^{i} = {u}^{i} + {v}^{b} Λ \\ 5 ) \frac{\partial {u}^{i}}{\partial t} + ∇ •ρ {u}^{i} = 0 \\ 6 ) ρ \frac{\partial {u}^{i}}{\partial t} + ρ {u}^{ i} • ∇ {u}^{i} = - ∇ p + η {∇}^{2} {u}^{i} \\ 7 ) \sum {f}^{ 2} = m ( {\dot{v}}^{b} )$$

Existing protein separation systems use several forces to separate proteins. For these current systems, the net fluid velocity (u) is zero because the systems either use a gel or a chromatographic membrane, both inertially at rest. The disclosed solution, in contrast, has been designed at the outset to work in a moving fluid in a channel.

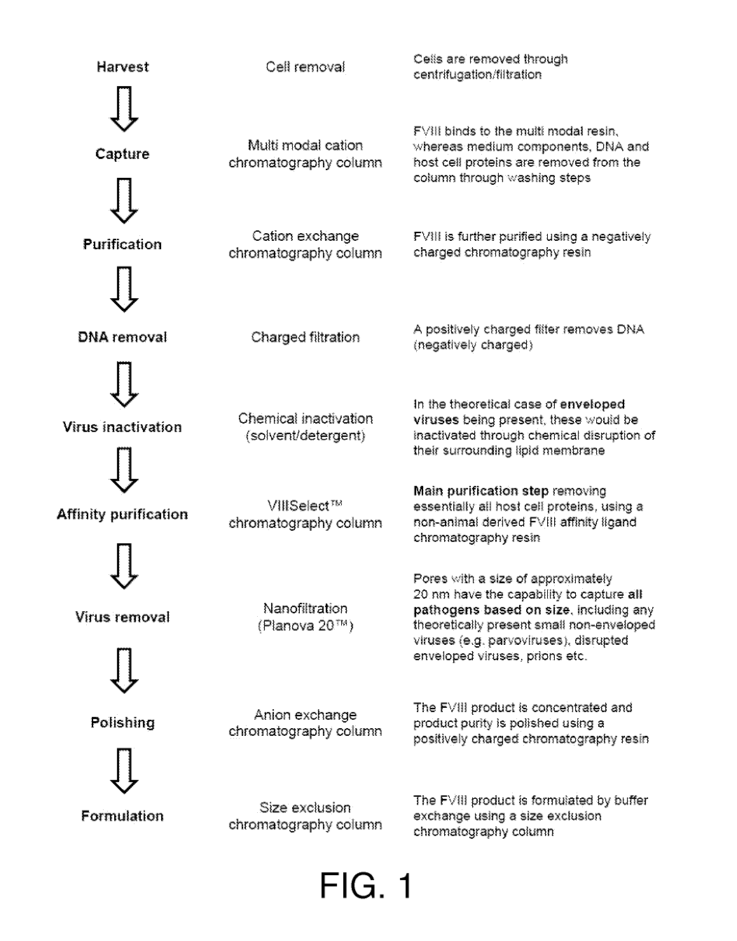

There are 4 fundamental point forces that act on the protein body of FIG. 1 as moves in the solution governed by Equation 6. These are the left hand terms of Equation 7) and are

$$8 ) {f}_{electrostatic} = qE \\ 9 ) {f}_{isoelectric} = α ∇ p H \\ 10 ) {f}_{magnetic} = q ( \tilde{u} B ) \\ 11 ) {f}_{viscous} = γ \vert u \vert \hat{u} \\ 12 ) \frac{\partial ( {ρφ}_{j} )}{\partial t} + ∇ • ( ρ \tilde{u} {φ}_{j} ) = - ∇ • ( ρ 𝒟 ∇ {φ}_{j} ) + S$$

Electrostatic force (Eq.8) can be generated by applying a voltage V across a channel of width d(m) to produce a vector field E=V/d. The isoelectric force (Eq. 9) is a property of charged molecules—including the aforementioned biologically active proteins, to experience a force linearly proportional to a spatial pH gradient. Lastly, if a magnetic field B is applied to a charged mass, a magnetic force is produced equal to the net charge multiplied by the vector product of the mass velocity u and the magnetic field B (Eq. 10). A viscous drag force (actually most beneficial for our design because it causes force-neutral protein motion to stabilize at a constant location rather than at a constant velocity) is described by Equation 11.

In addition to the bulk fluid and protein dynamic equations of motion, a final solution effect is diffusion where species (j) of concentration fj (mol/liter) tend to move from an area of high concentration of j to a lower concentration j. All the species of the buffer solution, lighter companion molecules and proteins in the feed stock thus obey the Convection Diffusion equation (Eq. 12) Where the fluid velocity (u) is the solution of Equation 6D is the species diffusivity (mol-sec), and S is the source (or sink) of species (j) entering (or exiting) the channel. The total protein motion solution then is provided by the time integral of Equation 4, with the bulk fluid solution from Equation 6 with 7, and with species (j) suspended in solution as the solution to Equation 12.

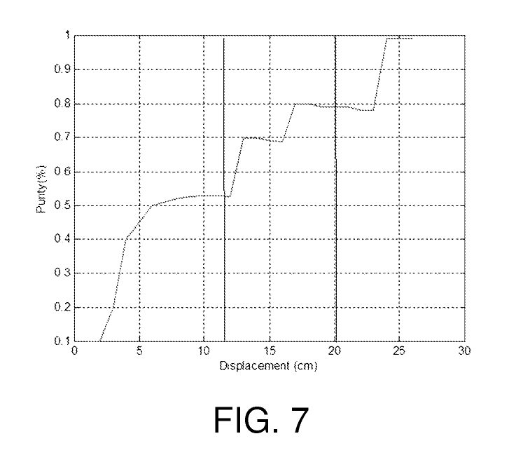

In order to show at least minimal operability of a transformational protein separation design using the unique properties of graphene, a first order assessment of the performance of each stage of an exemplary device of this invention was completed using nominal physical characteristics. FIG. 7 shows a representative plot of predicted purity vs. displacement (X) along an exemplary three stage harvesting system. The representative protein of interest used in the simulation is Bovine Serum Albumin (BSA). Table 2 provides the parameters used to represent BSA as they relate to Equations 1 through 8 below, where values are taken from R. F. Atmeh et al. (2007) Jordan Journal of Chemistry 2(2):169-182. It should be noted that it is well known to those skilled in the art that depending on temperature, solubility and chemical potential of the solvent mixture, proteins like BSA may obtain effective diameters ranging from 3 to 12 nm. For this representative simulation, holes of 11 nm diameters were chosen, and the overall diameter effect on simulated performance only relates to speed of accumulation, not overall purity.

TABLE 2

| POI Parameter and units | Nominal Value |
|---|---|
| POI Diameter (nm) | 11 |
| POI Mass, m (kg) | 1.16 × 10⁻²⁵ |
| POI charge, q (pKa) | 4.1 (dominant amino acid) |
| Bulk density, ρ (g/cm³) | 1.1 |
| Bulk Viscosity, γ (Pa-s) | 1.1 × 10⁻³ |

The simulation solves the general equation of motion for n POI molecules (where n can be set to one or more) in accordance with Equations 1-8 below by numerical integration. The spatial location of the perforated two-dimensional material membranes as shown in FIGS. 2 and 4 are parametrically entered. A preset pH gradient is established and modelled as a constant in the transverse (Y) direction to effect isoelectric point force on each POI molecule. The bulk channel velocity is initialized and maintained constant in the simulation at 0.1 m/s. The motion of the POI particles is computed and tracked relative to the windows, with logic to declare POI capture on the perforated membrane, if its position at least is tangent to the window's outside edge. To derive performance characteristics, stochastic Gaussian force noise (that is band limited to 100 Hz) is applied to each POI equation of motion, thereby randomizing its motion and introducing uncertainty that must be counterbalanced by managing the electric field across the channel. The simulation stopped and information stored after completing depletion of the POI particles, then re-initialized with different noise and re-computed to provide statistical significance. In this simulation stage 1 occupies displacement 0 to 12 cm, stage 2 occupies 12 to 20 cm and stage 3 occupies 20 cm to 30 cm. The crude separation of the first stage achieves approximately 50% purity as it removes bulk waste. The stage 2 operation is evident as sequential graphene “windows” remove competing proteins that are very close in size, but have different isoelectric points. The final stage 3 isolation achieves essentially 100% selectivity and purity in a single step.

What will be understandable to those skilled in the art is that by simple mechanical location and scaling, together with the standing wave tailoring, the same system may be easily and quickly reconfigured to isolate and harvest different proteins of interest with little to no equipment modification.

The disclosed invention at least in part makes novel use of these forces in context of bulk convective flow and diffusion to locate the proteins of interest at desired locations in (x, y) dynamically in real time to effect continuous harvest.

Table 3 below highlights the advantageous attributes against market competition, highlighting how the disclosed device and process is different.

TABLE 3

| | | | Current State Non-Membrane |
|---|---|---|---|
| | Current State | | Tech (chromatography/HPLC, |
| Discriminators | Membrane Tech | Graphene Platform | ion exchange, blots, etc.) |
| Exploits deep | Require ~3-4 | Physical size | Require multiple |
| understanding | multiple | exclusion paired | phases/steps/modules |
| physics and | phases/steps/modules | with electrical | for different purposes |
| chemistry of | for different | properties are | with distinct set up and |
| membrane | purposes with | unique to graphene | physical implementation |
| | distinct set up and | allow for one | |
| | physical | continuous flow in | |
| | implementation | an integrated | |
| | | purification strategy | |
| Simplicity of | ~3-4 units | 1 flow bench | Multiple phases |
| units/integration | | | |
| High quality of | (see above); limited | (see above) limited | Product bound and must |
| products (yield, | by steps (3-4) | by steps (1), better | be eluted and captured |
| purity) | | than current state | |
| | | per step | |
| Fouling | Thickness allows | All chemical action | |
| | fouling on top and in | on surface (planar, | |
| | membrane | no thickness) | |
| Scale up | More units in | Leverage high flux; | More units in parallel, or |
| | parallel, or multi | linear scale up | multi sized units |
| | sized units | | |
| Disposability (no | Disposable | Theoretical | Disposable or limited |
| need to validate | cartridges, single use | indefinite use; | use (cleaning, |
| cleaning | | graphene can | repacking, validation, |
| procedures) | | handle the heat of | maintenance and labor) |
| | | autoclaving | |
| | | (substrate | |
| | | dependent) and | |
| | | chemical cleaners | |
| Market | Single market, single | Device embodiment | Single market, single |
| proliferation | purpose | can capture market | purpose |
| | | share from | |
| | | chromatography | |
| | | and membranes | |

Although the disclosure has been described with reference to the disclosed embodiments, one having ordinary skill in the art will readily appreciate that these are only illustrative of the disclosure. It should be understood that various modifications can be made without departing from the spirit of the disclosure. The disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials and synthetic methods other than those specifically exemplified can be employed in the practice of the invention without resort to undue experimentation. All art-known functional equivalents, of any such methods, device elements, starting materials and synthetic methods are intended to be included in this invention. Whenever a range is given in the specification, for example, a temperature range, a time range, or a composition range, all intermediate ranges and subranges, as well as all individual values included in the ranges given are intended to be included in the disclosure. When a Markus group or other grouping is used herein, all individual members of the group and all combinations and sub combinations possible of the group are intended to be individually included in the disclosure.

As used herein, “comprising” is synonymous with “including,” “containing,” or “characterized by,” and is inclusive or open-ended and does not exclude additional, unrequited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The preceding definitions are provided to clarify their specific use in the context of the invention.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claims.

1. A device for separating a target component from a medium, comprising:
at least one charging area to apply an electrical field to the medium and components therein which locates the components in the medium in a direction perpendicular to the applied electric field according to a component's electrophoretic mobility or isoelectric point; and
at least one screening area associated with said charging area to separate the target component from other components of selected electrophoretic mobility or isoelectric point,
wherein the screening area comprises a membrane of perforated two-dimensional material wherein the hole sizes are chosen to block passage of components larger than a selected size.

2. The device according to claim 1, wherein the perforated two-dimensional material is a graphene-based material.

3. The device according to claim 1 or 2, further comprising:
at least one mixing area which receives the medium and components therein and a pH buffer solution to mix with the medium to establish a selected pH in the medium in the mixing area,
wherein said medium and the components including the target component therein achieve a positional equilibrium according to the electrophoretic mobility of the components.

4. The device according to claim 3 wherein the perforated two-dimensional membrane is positioned to selectively intersect with the positionally equilibrated components avoiding capture of the target component, yet capturing a portion of the components therein.

5. The device according to claim 1 further comprising:
at least one mixing area which receives the medium and components therein and an ampholyte mixture for establishing a pH gradient perpendicular to the electric field applied,
wherein said medium and the components including the target component therein achieve a positional equilibrium according to the isoelectric point of the components.

6. The device according to claim 5, wherein the pH gradient established ranges from 2-12.

7. (canceled)

8. (canceled)

9. The device according to claim 5, wherein the perforated two-dimensional membrane is positioned to selectively intersect with the positionally equilibrated components avoiding capture of the target component, yet capturing a portion of the components therein.

10. The device according to claim 5, wherein said medium and the components including the target component therein achieve a the positional equilibrium according to the density of said components.

11. The device according to claim 10, wherein the perforated two-dimensional membrane is positioned to selectively intersect with the positionally equilibrated components avoiding capture of the target component, yet capturing a portion of the components therein.

12. The device according to claim 1, wherein the two-dimensional material is conductive and the device further comprises a voltage source for application of a voltage to the perforated membrane of two-dimensional material.

13. A device of claim 1 comprising one or more stages wherein a second stage comprises:
the at least one charging area to apply an electrical field to the medium and components therein which locates the components in the medium in a direction perpendicular to the applied electric field according to a component's electrophoretic mobility or isoelectric point; and
the at least one screening area associated with said charging area to separate the target component from other components of selected electrophoretic mobility or isoelectric point.

14. The device of claim 13, wherein the second stage further comprises a mixing area which receives the medium and components therein and for introduction of a pH buffer solution to mix with the medium to establish a selected pH in the medium in the mixing area,
wherein said medium and the components including the target component therein achieve a positional equilibrium according to the electrophoretic mobility of the components.

15. The device according to claim 13, wherein the perforated two-dimensional membrane is positioned to selectively intersect with the positionally equilibrated components avoiding capture of the target component, yet capturing a portion of the components therein.

16. The device according to claim 13, wherein the second stage further comprises a mixing area which receives the medium and components therein and an ampholyte mixture for establishing a pH gradient perpendicular to the electric field applied,
wherein said medium and the components including the target component therein achieve a positional equilibrium according to the isoelectric point of the components.

17. The device according to claim 16, wherein the pH gradient established ranges from 2-12.

18. (canceled)

19. (canceled)

20. The device according to claim 16, wherein the perforated two-dimensional membrane is positioned to selectively intersect with the positionally equilibrated components avoiding capture of the target component, yet capturing a portion of the components therein.

21. The device according to claim 13, wherein said medium and the components including the target component therein achieve a positional equilibrium according to the density of said components.

22. The device according to claim 21, wherein the perforated two-dimensional membrane is positioned to selectively intersect with the positionally equilibrated components avoiding capture of the target component, yet capturing a portion of the components therein.

23. The device according to claim 13, wherein the two-dimensional material is conductive and the device further comprises a voltage source for application of a voltage to the perforated membrane of two-dimensional material.

24. The device of claim 13 which further comprises a first stage providing a separation of components in the medium by density or by size.

25. The device of claim 13 which further comprises a first stage providing a separation of components by size wherein separation by size is by passage of the medium through a perforated membrane of two-dimensional material.

26. The device of claim 1 any one of claims 1 further comprising a perforated two-dimensional membrane for capturing the target component after its separation by electrophoretic mobility or isoelectric point.

27. A method for separating a target component from a medium containing the target component and other components which comprises:
establishing a flow of medium applying an electric field perpendicular to the flow direction and locating the components of the medium including the target medium by position in the flow according to electrophoretic mobility or isoelectric point of the target or other component and selectively intersecting the flow with a perforated membrane of two-dimensional material to avoid capture of the target component and capture at least a portion of the other components to thus separate the target component from other components.

28. The method of claim 27 wherein the target component is captured by a membrane of perforated two-dimensional material after its separation from other components by electrophoretic mobility of isoelectric point.
